(19) United States
(12) Patent Application Publication
(10) Pub. No.: US 2024/0209219 A1
(43) Pub. Date: Jun. 27, 2024

(54) ANTIVIRAL COATINGS

(71) Applicant: Inhibit Coatings Limited, Wellington (NZ)

(72) Inventors: James Howard Johnston, Wellington (NZ); Eldon Warwick Tate, Wellington (NZ)

(21) Appl. No.: 18/597,778

(22) Filed: Mar. 6, 2024

Related U.S. Application Data
(63) Continuation of application No. PCT/NZ2021/050159, filed on Sep. 7, 2021.

(51) Int. Cl. C09D 5/14; C09D 7/40; C09D 7/61; C09D 125/14; C09D 175/04

(52) U.S. Cl. CPC C09D 5/14; C09D 7/61; C09D 7/67; C09D 125/14; C09D 175/04

(57) ABSTRACT

Disclosed are antiviral coatings comprising silver nanoparticles, methods of their preparation and uses thereof. The antiviral coatings include silver nanoparticles bound to polyurethane polymers, acrylic polymers, and polyols bound to via the respective functional groups. The antiviral coatings have a very low silver leach rate. The silver nanoparticles are formed by reduction of silver ions by the functional groups. Further, the silver nanoparticles are stabilised by the interactions with the functional groups.

### TECHNICAL FIELD

The invention relates to antiviral coatings. More specifically, the present invention relates to antiviral coatings comprising silver nanoparticles, methods of their preparation and uses thereof.

### BACKGROUND

Viruses are a collection of molecules that require a living host cell in order to replicate. Whilst viruses possess genetic information, they lack a cellular structure and their own metabolism. Viral populations do not grow through cell division, but rather use the machinery and metabolism of a host cell to replicate.

Morphologically, viruses can be classified by their shape, size, and by the presence of an envelope. Viruses can be either enveloped or non-enveloped. Where present, the envelope is often derived from the host's plasma membrane during their release from the cell. Glycoproteins are incorporated into the envelope in the form of spikes that facilitate entry into host cells. Viral envelopes can degrade upon harsh physical or chemical conditions. Non-enveloped viruses tend to be more environmentally stable and resistant to detergents and heat. The majority of recent viral epidemics have been caused by enveloped viruses, including Ebola, measles, Zika, avian influenzas, SARS, MERS and COVID-19.¹

The Baltimore system classifies viruses into seven categories. Each class represents one way a virus obtains mRNA from its starting genetic material, which can be either DNA (classes 1, 2 and 7), or RNA (classes 3, 4, 5, and 6). Classes are further divided by whether the starting genetic material is single or double stranded, and by the process the virus obtains mRNA.

### Transmission

Viruses spread through a population via several routes of transmission, including direct or indirect contact, aerosols and droplets. Transmission often occurs by a person touching a surface contaminated with an active virus.

Viral persistence on surfaces depends on the type of virus, with different viruses exhibiting differing levels of stability and viability on surfaces. Major contributing factors affecting viral persistence include porosity, absorption and hydrophobicity of the surface.

### Antivirals

Antivirals are materials that prevent the replication of viruses, either by preventing them from interacting with their host cell, or by damaging the virus to the extent that it is unable to replicate.

Due to the differences between viruses and other types of microorganisms (e.g. bacteria, fungi, protozoa) antimicrobial biocides that exploit antibacterial and antifungal mechanisms such as upsetting metabolic pathways, inhibiting respiration, and degrading a cellular structure, are often ineffective as antiviral agents. Furthermore, it cannot be presumed that materials showing antiviral activity against one type of virus will have antiviral activity against another type of virus.

Antiviral formulations are increasingly used to inactivate and remove viruses from surfaces. Such formulations are directly applied and optionally wiped off a surface. The formulations only have a temporary antiviral effect. Under a traditional disinfecting cleaning method, the bioburden level on the cleaned surface returns to the state of the precleaned surface within 2.5 hours.² In order to be effective, the antiviral formulations must be applied regularly.

### Silver-Containing Surfaces

Surface coatings comprising silver are known to have an antimicrobial effect, and coatings comprising silver nanoparticles (AgNPs) have demonstrated substantial efficacy against bacteria. For example, AgNPs have been incorporated into household paint.³ In addition, WO 2018/208177 describes polymers functionalised with AgNPs that demonstrate antibacterial and antifouling activity. Silver nanoparticle coated polyurethane condoms have also been developed to inhibit infectious viruses such as HIV and Herpes simplex virus (HSV).⁴

Even though silver is a known biocide, there are few published studies on the antiviral efficacy of silver or AgNPs. Jeremiah et al. found an increasing antiviral efficacy of aqueous AgNPs against SARS-Cov-2 as the silver concentration was increased from 0.1 ppm to 10 ppm. However, an antiviral effect was only observed when AgNPs were first mixed with the SARS-Cov-2 virus before being added to cells, and that cells pre-treated with AgNPs were unable to resist viral infection.⁵ Elechiguerra et al. found the same trend with HIV over a similar concentration range.⁶ Elechiguerra et al. showed that AgNPs completely surround and bind to the HIV virus structure. However, only AgNPs that were dispersed in solution were observed to interact with the virus. The results of the Jeremiah and Elechiguerra studies indicate that the observed antiviral effect of AgNPs resulted from them surrounding and binding to the virus structure which then prevents the virus from binding to or entering the host cell. This process requires the AgNPs to have freedom of movement associated with being in solution.

The antiviral mechanisms of AgNPs are complex and not well understood, and therefore the degree of antiviral activity for a AgNP is difficult to predict. Achieving antiviral activity of AgNPs bound in a composite surface coating is even more poorly understood than AgNPs alone. It is also difficult to predict antiviral activity for composite materials comprising AgNPs. In some cases, observed antiviral activity of metals, including metal nanoparticles, is believed to be properly attributed to metal ions leaching from the metals or metal nanoparticles leaching from a surrounding composite. Leaching of silver ions or silver metal poses dangers to the environment and to human health.

In any event, studies suggest AgNP antiviral activity is affected by the concentration, size, shape, and charge (zeta potential) of the AgNPs.⁷⁸ Self-agglomeration of AgNPs reduces antiviral activity. Environmental pollution interacting with AgNPs is also known to drastically diminish antiviral efficacy.^{9 10}

The applicant has surprisingly found new antiviral coating materials comprising AgNPs bound to polymers, where there is a bonding interaction or a strong association between the AgNP and the polymer. The AgNP functionalised polymers yield a non-leaching or low leaching coating material with antiviral activity, without compromising the properties of the polymer itself.

### SUMMARY OF THE INVENTION

In one aspect, there is provided a use of a composition comprising a polymer bound to silver nanoparticles as an antiviral coating, wherein the polymer is selected from polyurethane polymer, acrylic polymer, and polyol.

The use as an antiviral coating is preferably to inactivate one or more of feline calicivirus, human norovirus, human coronavirus, influenza A H1N1 virus.

Preferably, the silver nanoparticles are capped by functional groups of the polymer. The functional groups may be selected from carboxyl, sulfonate, ammonium, ester, ether, amine, imine, nitrile, epoxide, hydroxyl, carbamate, or carbonyl groups.

Preferably, the polyurethane polymer comprises a waterborne polyurethane polymer. For example, the composition preferably comprises a polyurethane polymer dispersed in water.

Preferably, the acrylic polymer is selected from methyl acrylate, ethyl acrylate, butyl acrylate, methyl methacrylate, butyl methacrylate, styrene-acrylic polymer.

Preferably, the polyol is selected from polyether polyol, polyester polyol, polycarbonate polyol, polyacrylate polyol, poly(meth)acrylate polyol.

Preferably, the composition and/or coating comprise at least 0.05 wt. % Ag⁰, at least 0.1 wt. % Ag⁰, at least 0.25 wt. % Ag⁰, or at least 0.5 wt. % Ag⁰.

The antiviral coating may comprise a crosslinked polymer network.

Preferably, the coating has a leach rate of Ag of less than 100 parts per billion per gram of set composite per day (ppb/g/day).

Preferably, the coating achieves an average percent reduction in viral titer by at least 20%, according to JIS Z 2801 test protocol.

Preferably, the coating achieves an average percent reduction in H1N1 viral titre of at least 20%, according to JIS Z 2801 test protocol.

Preferably, the coating achieves an average percent reduction in human coronavirus viral titre of at least 50%, according to JIS Z 2801 test protocol.

Preferably, the coating achieves an average percent reduction in feline calicivirus viral titre of at least 40%, according to JIS Z 2801 test protocol.

Where the polymer is an acrylic polymer, the coating preferably achieves an average percent reduction in viral titre of at least 80%, at least 85%, at least 90%, at least 95%, at least 98%, at least 99%, at least 99.5% against Feline Calicivirus and human norovirus, according to JIS Z 2801 test protocol.

Where the polymer is a polyurethane polymer dispersed in water, the coating preferably achieves an average percent reduction in viral titre of at least 90%, according to JIS Z 2801 test protocol. Antiviral coatings comprising the polyurethane polymer dispersed in water may achieve an average percent reduction in viral titre of at least 80%, at least 85%, or at least 90% against Feline Calicivirus and human norovirus, according to JIS Z 2801 test protocol. Antiviral coatings comprising the polyurethane polymer dispersed in water may achieve an average percent reduction in viral titre of at least 80%, at least 85%, at least 90%, at least 95%, at least 98% or at least 99% against Human Coronavirus, according to JIS Z 2801 test protocol. Antiviral coatings comprising the polyurethane polymer dispersed in water may achieve an average percent reduction in viral titre of at least 80%, at least 85%, at least 90%, at least 95%, or at least 98% against Influenza H1N1, according to JIS Z 2801 test protocol.

Where the polymer is a styrene-acrylic copolymer, the coating preferably achieves an average percent reduction in viral titre of at least 75%, according to JIS Z 2801 test protocol. Antiviral coatings comprising the styrene-acrylic polymer may achieve an average percent reduction in viral titre of at least 80%, at least 85%, at least 90%, at least 95%, at least 98%, or at least 99%, or at least 99.9% against Feline Calicivirus and human norovirus, according to JIS Z 2801 test protocol. Antiviral coatings comprising the styrene-acrylic polymer may achieve an average percent reduction in viral titre of at least 80%, at least 85%, at least 90%, at least 95%, at least 98%, or at least 99%, against Human Coronavirus, according to JIS Z 2801 test protocol.

In a further aspect, there is provided a method of inactivating viruses on a substrate, comprising the steps of:
a) applying to a substrate a composition comprising a polymer bound to silver nanoparticles; and
b) allowing the composition to form a coating on the surface of the substrate;
wherein the polymer is selected from a polyurethane polymer, an acrylic polymer, and a polyol.

Preferably, the coating inactivates one or more of feline calicivirus, human norovirus, human coronavirus, influenza A H1N1 virus.

Preferably, the method comprises, prior to step (a), forming a polymer bound to silver nanoparticles by contacting the polymer with a silver salt. Preferably, the polymer is bound to the silver nanoparticle by bonding interactions.

The method may further comprise, prior to step a), reducing silver ions by the functional groups of the polymer to form the silver nanoparticles bound to the polymer.

The method may further comprise, prior to step a), reducing silver ions by the functional groups of the polymer, without the addition or application of an external reducing agent.

The method may further comprise, prior to step a), stabilising the silver nanoparticles by forming a bonding interaction with the polymer.

The silver nanoparticles are preferably formed by reduction of silver ions by the functional groups of the polymer. The silver nanoparticles are preferably formed by reduction of silver ions by the polymer prior to applying the composition to the substrate in step (a). The silver nanoparticles are preferably formed without the addition or application of an external reducing agent. For example, the external reducing agent not required may include UV light, radical initiators, polymerising agents or heating at a temperature of 100° C. or greater. The external reducing agent that is not required may be selected from the group comprising trisodium citrate, sodium borohydride, hydroxylamine hydrochloride, hydrazine, ascorbic acid, ethylenediaminetetraacetic acid (EDTA), polyvinvylpyrrolidone, dimethylformamide, plant extracts, hydrogen gas, and radical initiators.

The silver nanoparticles are preferably capped by functional groups of the polymer. The silver nanoparticles are stabilised by the polymer to prevent or minimise agglomeration of silver nanoparticles without the addition of an external stabiliser. For example, external stabilisers that are not required include trisodium citrate, polyvinylpyrrolidone, polyvinyl alcohol, oleylamine, cetyl trimethylammonium bromide, poly(N-isopropylacrylamide), sugars, and fatty acids.

The acrylic polymer is preferably selected from methyl acrylate, ethyl acrylate, butyl acrylate, methyl methacrylate, butyl methacrylate, styrene-acrylic polymer. The acrylic polymer is preferably a styrene-acrylic copolymer.

The polyol is preferably selected from polyether polyol, polyester polyol, polycarbonate polyol, polyacrylate polyol, poly(meth)acrylate polyol.

Preferably, the polyurethane polymer is a waterborne polyurethane polymer. For example, the composition preferably comprises a polyurethane polymer dispersed in water.

Preferably, the composition and/or coating comprise at least 0.05 wt. % Ag⁰, at least 0.1 wt. % Ag⁰, at least 0.25 wt. % Ag⁰, or at least 0.5 wt. % Ag⁰.

Preferably, the composition is a liquid composition. The composition is preferably a water-borne dispersion, suspension or emulsion comprising the polymer.

Preferably, setting the composition comprises crosslinking the polymer.

Where the polymer comprises a polyurethane polymer dispersed in water, the coating preferably achieves an average percent reduction in viral titre of at least 90%, according to JIS Z 2801 test protocol.

Where the polymer comprises a styrene-acrylic copolymer, the coating preferably achieves an average percent reduction in viral titre of at least 75%, according to JIS Z 2801 test protocol.

Where the polymer is a polyurethane polymer dispersed in water, the method preferably comprises, prior to step (a), contacting the waterborne polyurethane with a silver salt. Where the polymer is a polyurethane polymer dispersed in water, the method preferably further comprises the addition of a pH modifier to the polyurethane polymer dispersed in water. The pH modifier may be added prior to or simultaneously with the silver ions. The pH modifier may be selected from ammonia, triethanolamine, ethylenediamine, 2-amino-2-methyl-1-propanol, triethylamine, or N,N-diisopropylethylamine.

In another aspect, there is provided a use of a liquid composition comprising a polymer bound to silver nanoparticles in the preparation of an antiviral coating on a substrate, wherein the polymer is selected from polyurethane, acrylic polymer, and polyol.

The liquid composition is preferably applied to a substrate and set to form an antiviral coating.

In a further aspect, there is provided an antiviral composition comprising a polymer bound to silver nanoparticles, wherein the polymer is selected from a polyurethane polymer, an acrylic polymer, and a polyol.

In a further aspect, there is provided a coating on a surface, comprising a composition comprising a polymer bound to silver nanoparticles, wherein the polymer is selected from a polyurethane polymer, an acrylic polymer, and a polyol.

The composition preferably has antiviral activity against any of feline calicivirus, human norovirus, human coronavirus, and influenza A H1N1 virus.

Preferably, the coating achieves an average percent reduction in viral titer by at least 20%, according to JIS Z 2801 test protocol.

Preferably, the coating achieves an average percent reduction in H1N1 viral titre of at least 20%, according to JIS Z 2801 test protocol.

Preferably, the coating achieves an average percent reduction in human coronavirus viral titre of at least 50%, according to JIS Z 2801 test protocol.

Preferably, the coating achieves an average percent reduction in feline calicivirus viral titre of at least 40%, according to JIS Z 2801 test protocol.

Where the polymer is a waterborne polyurethane polymer, the coating preferably achieves an average percent reduction in viral titre of at least 90%, according to JIS Z 2801 test protocol.

Where the polymer is a styrene-acrylic copolymer, the coating preferably achieves an average percent reduction in viral titre of at least 75%, according to JIS Z 2801 test protocol.

The coating may comprise a crosslinked polymer network.

The coating preferably has a leach rate of Ag of less than about 100 parts per billion per cm² per day (ppb/cm²/day), or less than about 100 parts per billion per gram of coating per day (ppb/g/day).

In another aspect, there is provided a composition comprising a polyurethane polymer dispersed in water, and silver nanoparticles, wherein the silver nanoparticles are bound to functional groups of the polyurethane polymer.

The silver nanoparticles are preferably formed by reduction of silver ions by functional groups of the polymer, and are preferably formed without the addition or application of an external reducing agent. For example, the external reducing agent not required may include UV light, radical initiators, polymerising agents or heating at a temperature of 100° C. or greater. The external reducing agent that is not required may be selected from the group comprising trisodium citrate, sodium borohydride, hydroxylamine hydrochloride, hydrazine, ascorbic acid, ethylenediamninetetraacetic acid (EDTA), polyvinvylpyrrolidone, dimethylformamide, plant extracts, hydrogen gas, and radical initiators.

The silver nanoparticles are preferably capped by functional groups of the polymer. The silver nanoparticles are stabilised by the polymer to prevent or minimise agglomeration of silver nanoparticles without the addition of an external stabiliser. For example, external stabilisers that are not required include trisodium citrate, polyvinylpyrrolidone, polyvinyl alcohol, oleylamine, cetyl trimethylammonium bromide, poly(N-isopropylacrylamide), sugars, and fatty acids.

The functional groups of the polyurethane polymer may be selected from carboxyl, sulfonate, ammonium, ester, ether, amine, imine, nitrile, epoxide, hydroxyl, carbamate, or carbonyl groups.

The silver nanoparticles preferably have an average particle size of less than 50 nm.

Preferably, the composition comprises a waterborne polyurethane dispersion (PUD).

In another aspect, there is provided a use of a composition comprising a polyurethane polymer dispersed in water, and silver nanoparticles, wherein the silver nanoparticles are bound to functional groups of the polyurethane polymer, as an antiviral coating on a substrate. Preferably, the composition has antiviral activity against one or more of feline calicivirus, human norovirus, human coronavirus, influenza A H1N1 virus. Preferably, the composition is used to achieve an average percent reduction in viral titre of at least 90%, according to JIS Z 2801 test protocol.

In another aspect, there is provided a method of preparing a composition comprising a polyurethane polymer dispersed in water, and silver nanoparticles, wherein the silver nanoparticles are bound to functional groups of the polyurethane polymer, comprising contacting the polyurethane polymer with silver ions, wherein at least some of the silver ions are reduced to metallic silver nanoparticles by the functional groups of the polymer, without the addition or application of an external reducing reagent.

The method preferably further comprises the addition of a pH modifier to the polyurethane polymer dispersed in water. The pH modifier may be added prior to or simultaneously with the silver ions. The pH modifier may be selected from ammonia, triethanolamine, ethylenediamine, 2-amino-2-methyl-1-propanol, triethylamine, or N,N-diisopropylethylamine.

The polymer may be contacted with a solution of a silver salt. Examples of silver salts include those selected from the group comprising silver nitrate, silver acetate, silver carbonate, silver perchlorate, silver phosphate, silver trifluoroacetate, silver benzoate, and silver lactate.

In another aspect, there is provided a use of a composition comprising a polyurethane polymer dispersed in water, and silver nanoparticles, wherein the silver nanoparticles are bound to functional groups of the polyurethane polymer, as an antibacterial coating on a substrate. Preferably, the composition has antibacterial activity against Staphylococcus aureus. Preferably, the composition is used to achieve an average percent reduction in viral titre of at least 99.9% against S. aureus, according to JIS Z 2801 test protocol.

### BRIEF DESCRIPTION OF THE FIGURES

FIG. 1 shows a UV-Visible spectrum of a liquid composition comprising AgNP functionalised waterborne styrene-acrylate copolymer (Carboset 3090) comprising 0.5 wt. % silver, prepared according to Example 3. The localised surface plasmon resonance (LSPR) peak at 462 nm is indicative of silver nanoparticles.

FIG. 2 shows a UV-Visible spectrum of a liquid composition comprising AgNP functionalised waterborne 1-component polyurethane dispersion (Aptalon W8060) comprising 0.5 wt. % silver, prepared according to Example 4a. The LSPR peak at 419 nm is indicative of silver nanoparticles. The peak at 557 nm is believed to be a second LSPR peak, indicating a bimodal size distribution or anisotropy.

FIG. 3 shows an XRD diffractogram of the composition of an AgNP functionalised waterborne 1-component polyurethane (Aptalon W8060) comprising 0.5 wt. % silver, prepared according to Example 4a, applied to a substrate and allowed to set. The peaks at 38.1°, 44.2°, 64.5°, and 77.3° correspond to the (111), (200), (220), and (311) planes of silver.

FIG. 4 shows a scanning electron microscopy image of an AgNP functionalised waterborne 1-component polyurethane (Aptalon W8060) comprising 0.5 wt. % silver, prepared according to Example 4a, applied to a substrate and allowed to set. The average particle size of the AgNPs is 27 nm, the minimum particle size is 15 nm, and the maximum particle size is 43 nm.

FIG. 5 shows a UV-Visible spectrum of a liquid composition comprising a 2-component polyurethane (Albodur) comprising an AgNP functionalised polyol component (Albodur polyol component) comprising 0.14 wt. % silver, prepared according to Example 5. The LSPR peak at 435 nm is indicative of silver nanoparticles.

### DETAILED DESCRIPTION

Described herein are compositions comprising a polymer and silver nanoparticles, wherein the silver nanoparticles are bound to functional groups of the polymer, methods for their preparation, and uses thereof. The compositions described herein have surprising antiviral activity across different types of viruses.

### Definitions

The term “nanoparticle” means any particle having at least one dimension, e.g. diameter, in the range of several nanometres to several hundred nanometres.

The term “reducing agent” means a compound or substance that loses (or donates) an electron to another chemical species in a redox chemical reaction and as a consequence reduces the oxidation state of that chemical species.

The term “external reducing agent” means a reducing agent that has been added or applied from an external source.

The term “functional group” means a group of atoms or bonds responsible for the characteristic reactions of a particular compound.

The term “agglomeration” means the action or process of clustering or grouping of matter.

The term “stabiliser” means an additive that helps maintain the structure of a composite where silver particles are dispersed throughout the composite and minimises agglomeration of the silver particles.

The term “capping” means stabilising the nanoparticle by a bonding interaction with the capping agent. In the present invention, the polymer is the capping agent of the silver nanoparticles.

The term “antiviral” means materials that prevent the replication of viruses, either by preventing them from interacting with their host cell, or by damaging the virus to the extent that it is unable to replicate.

The term “inactivate” and the like in relation to viruses means killing viruses, or otherwise rendering viruses unable to replicate. The term is intended to be consistent with the success criteria of JIS Z 2801 (as modified for viruses), and applies to both enveloped and non-enveloped viruses.

### Polymer

The polymer used for preparing antiviral coating compositions of the invention comprises one or more functional groups capable of reducing silver ions to AgNPs. The polymer is preferably an acrylic polymer, a polyol, or a polyurethane polymer. The functional groups are not limited to any particular reducing functional groups. Examples of functional groups include carboxyl, sulfonate, ammonium, ester, ether, amine, imine, nitrile, epoxide, hydroxyl, carbamate, or carbonyl groups.

The functional groups may be part of the polymer backbone.

### Acrylic Polymers

Acrylic polymers are preferably water-borne emulsions or dispersions. Acrylic polymers may include a single species of monomer or be produced as a copolymer. Examples of acrylic polymers include methyl acrylate polymers, ethyl acrylate polymers, butyl acrylate polymers, methyl methacrylate polymers, and butyl methacrylate polymers. An example of a commercial acrylic polymer suitable for functionalising with silver nanoparticles includes NeoCryl™ XK-98 (DSM Coating Resins, LLC). Another example of a suitable acrylic polymer is an acrylic copolymer, and in particular a styrene-acrylic copolymer. An example of a commercial styrene-acrylic copolymer suitable for the present invention is Carboset™ CR-3090 (Lubrizol Advanced Materials, Inc).

### 2-Part Polyurethane Polymers

2-part polyurethane coatings are produced via the step-growth polymerisation of a polyol and isocyanate which are commonly labelled as the “resin” and “hardener” component, respectively. These are mixed at the time of application to produce the polyurethane coating via polymerisation. Upon combining, the isocyanate and polyol components polymerise via the step-growth polymerisation mechanism. Isocyanate functional groups react with water to form carbon dioxide, so resin and hardener components of polyurethane systems are non-aqueous, and cannot be waterborne.

The polyols in 2-component polyurethane systems should be suitable for polymerisation with isocyanate components to produce polyurethane coatings. Examples of suitable polyols include polyether polyols, polyester polyols, polycarbonate polyols, and poly(meth)acrylate polyols. An example of a commercial polyol suitable for functionalising with silver nanoparticles according to the method described herein is Albodur X115.

Examples of suitable isocyanates include aliphatic and aromatic isocyanates.

### Waterborne Polyurethane Polymers

Waterborne polyurethane polymers are polyurethane polymers dispersed in water, and are sometimes known as polyurethane dispersions (PUDs). PUDs are formed by the reaction of a polyol and an isocyanate during the synthesis stage to produce a water dispersible polyurethane prepolymer. The polyol monomer may include polyether polyols, polyester polyols, polycarbonate polyols, polyacrylate polyols, and poly(meth)acrylate polyols. The isocyanate monomer may include toluene diisocyanate (TDI) or methylene diphenyl diisocyanate (MDI).

In general, polyurethanes are hydrophobic and insoluble in water. For polyurethanes to be dispersible in water, they must be modified by, for example, incorporating water-soluble groups such as ionic groups and/or non-ionic hydrophilic segments into the polymer structure. Emulsification in the aqueous phase may be obtained by polymerising an additional water-soluble monomer with the polyol and isocyanate. These monomers commonly have anionic, cationic or non-ionic side groups which provide internal emulsification of the polymer in water. Examples of side group moieties for emulsifying monomers include carboxylate, sulfonate, quaternary ammonium and poly(ethylene oxide).

An example of a commercial PUD suitable for functionalising with silver nanoparticles according to the method described herein is Aptalon™ W8060 (Lubrizol Advanced Materials, Inc)

### Method of Preparation of the Functionalised Polymer

To prepare an AgNP-functionalised polymer, the polymer is preferably carried in a suitable liquid solvent, and is contacted with a source of silver ions, such as a silver salt, and mixed.

The silver ions used to form the AgNPs are typically in the form of an aqueous solution of silver nitrate, silver acetate, silver carbonate, silver perchlorate, silver phosphate, silver trifluoroacetate, silver benzoate, or silver lactate. Silver nitrate is a preferred silver salt. Non-aqueous solutions of silver salts can also be used.

In some embodiments, the addition of a pH modifier may be required prior to or simultaneously with the addition of the silver salt. A pH modifier is used to at least partially counteract the pH change caused by the addition of silver nitrate and other silver salts. Examples of pH modifiers that may be used include ammonia, triethanolamine, ethylenediamine, 2-amino-2-methyl-1-propanol, triethylamine, or N,N-diisopropylethylamine. A preferred pH modifier is ammonia. The addition of a pH modifier is particularly preferred for the functionalisation of 1-component polyurethane dispersions.

The reduction of silver ions to AgNPs occurs within 48 hours, preferably 24 hours, at temperatures of about 20° C. and above. For example, the composite may be prepared by mixing at temperatures between 20 and 100° C., 20 and 90° C., 20 and 80° C., 20 and 70° C., 20 and 60° C., 20 and 50° C., 20 and 40° C., or 20 and 30° C.

The AgNPs are formed by reduction of the silver ions by the polymer. The AgNPs are formed before the polymer is set by cross-linking, curing, further polymerisation, or other hardening process.

The method is preferably carried out without the application or addition of an external reducing agent, without using UV light or heating to a temperature of 100° C. or greater. The reduction of silver ions to silver nanoparticles is not via a radical-initiated polymerisation reaction. Reduction reaction mechanisms using radical mechanisms, external reducing agents, UV light or heat result in the formation of nanoparticles that are not bonded to the polymer, and consequently are more prone to leaching. Examples of external reducing agents that are not applied or added include trisodium citrate, sodium borohydride, hydroxylamine hydrochloride, hydrazine, ascorbic acid, ethylenediaminetetraacetic acid (EDTA), polyvinylpyrrolidone, dimethylformamide, a plant extract, or hydrogen gas. The method is preferably carried out without the use of a radical initiator.

The method is preferably carried out without the application or addition of an external stabiliser. The use of external stabilisers as capping agents for nanoparticles means that the nanoparticles are not bonded to the polymer, and consequently are more prone to leaching. Examples of such stabilisers include trisodium citrate, polyvinylpyrrolidone, polyvinyl alcohol, oleylamine, cetyl trimethylammonium bromide, poly(N-isopropylacrylamide), sugars and fatty acids.

The polymer may be combined with pigments, dyes and/or fillers prior to the functionalisation of the polymer with silver nanoparticles. For example, the inventors found that the presence of pigments, dyes and/or fillers did not prevent successful reduction of the Ag⁺ to Ag⁰ nanoparticles within the acrylic and styrene acrylic coatings described in the Examples.

### Silver Nanoparticle

### Concentration

The coating composition comprises Ag⁰ concentrations in the range of 0.01 to 1 wt %. Preferred concentrations are in the range of 0.01 to 1 wt %, and more preferred concentrations are in the range of 0.01 to 0.5 wt %. The inventors have tested coatings comprising between 0.1 and 0.5 wt. % Ag⁰ for antiviral activity. Preferred concentrations are at least 0.05 wt % Ag.

### Size

Preferably, the composition comprises silver nanoparticles with an average diameter of less than 50 nm, or less than 30 nm. Preferably the composition comprises silver nanoparticles with a diameter of between 1 and 50 nm. Distributions of particle sizes of AgNPs are acceptable, for example, at least 50%, 60%, 70%, 80%, or 90% of nanoparticles in the composition preferably have a diameter of between 1 and 50 nm.

The Examples described herein show that the AgNP size in the functionalised polymers is related to the type of polymer used to reduce the silver ions to AgNPs, and the methods of functionalisation.

### Functionalised Polymer

The invention utilises the inherent functionality of the polymer to act as a dual reductant and stabiliser. In reducing silver ions to silver nanoparticles and stabilising (or capping) the nanoparticles, the polymer and nanoparticles are bonded together, which may be used to form a coating of AgNP-functionalised polymer having a very low silver leach rate.

The AgNP-functionalised polymer is prepared without the need for an application or addition of an external reducing agent or a radical initiator. Accordingly, in preferred embodiments, compositions comprising, or for preparing, the AgNP-functionalised polymer do not comprise radical initiators or external reducing agents.

Stabilisation of the AgNPs formed is necessary to ensure dispersion of the nanoparticles throughout the polymer matrix. Otherwise, agglomeration of the nanoparticles occurs leading to reduced or absent antiviral activity. Insufficient stabilisation of nanoparticles also leads to leaching of Ag, which has an adverse environmental impact and a decreasing antiviral activity of the composite over time.

The AgNP-functionalised polymer of the present invention is prepared without the application or addition of an external stabiliser. The AgNP-functionalised polymer therefore comprises AgNPs that are stabilised and capped by the polymer itself. The AgNP-functionalised polymer does not require external stabilisers or capping agents such as trisodium citrate, polyvinylpyrrolidone, polyvinyl alcohol, oleylamine, cetyl trimethylammonium bromide, poly(N-isopropylacrylamide), sugars, and fatty acids.

A bonding interaction links the polymer and AgNP in the AgNP-functionalised polymer. The AgNP may be bound to a functional group on the polymer backbone. The bonding interaction may be a strong bonding attraction. Where the bonding interaction is a strong bonding attraction, the bonding interaction may be covalent in character.

The bonding interaction of AgNPs with the polymer leads to advantages over other silver nanoparticle polymer composites. The bonding interaction yields a non-leaching or low leaching coating material with an extended antiviral life, without compromising the properties of the polymer itself. The bonding interaction of the AgNP to the polymer prevents leaching of the silver. The leach rate of Ag has been found to be less than about 100 parts per billion per cm² per day (ppb/cm²/day), or less than 100 parts per billion per gram of set composite per day (ppb/g/day). The low leach rate provides a longer antiviral life time to the coating, while also mitigating any adverse environmental effects that can occur due to high concentrations of leached silver. The strong associations, which may be covalent bonds or other types of interactions, appear to be a direct result of formation of the silver nanoparticles by reduction of silver ions by functional groups of the polymer.

Known coatings comprising polymers and AgNPs rely on the solidification, curing, or cross-linking process of the polymer to immobilise the AgNPs. The AgNPs in these systems are therefore physically confined within the material with little to no stabilising bonding interactions between the AgNP and the polymer. Such systems have the potential to leach significant amounts of silver during their lifetime. Indeed, for many of these systems, it is believed that the antibacterial effect observed is due to the leaching of silver from the coating onto the surface.

Example 1 describes the synthesis method for preparing an AgNP-functionalised acrylic polymer. Aqueous polymethylmethacrylate (PMMA) acrylic emulsion was reacted with silver nitrate to produce a liquid composition comprising AgNP-functionalised PMMA. A set (crosslinked) sample of AgNP-functionalised PMMA was found to have a silver leach rate of 4.0 (±0.9) ppb per gram of set sample, and an average AgNP particle size of 13 nm (±7 nm), with an AgNP particle size distribution of between 4 and 30 nm.

The presence of pigments and fillers did not prevent successful reduction of the Ag⁺ to Ag nanoparticles within the coatings by the PMMA, nor did it affect the antibacterial activity exhibited by the coatings (Example 2).

The synthesis method in Example 1 was applied in Example 3 to styrene-acrylic copolymers in the preparation of a 0.5% Ag (wt. %) AgNP functionalised styrene-acrylic polymer. UV-Visible spectroscopy of the liquid compositions comprising the AgNP-functionalised polymer confirmed the formation of AgNPs in the AgNP-functionalised styrene-acrylic copolymer. A leach rate of 4.4 (±1.2) ppm silver per gram of set sample was observed, indicating the presence of silver and AgNPs that are not bound to the polymer.

Examples 4a and 4b demonstrate methods of functionalising a waterborne polyurethane dispersion. A composition comprising a dispersed polyurethane polymer is combined with an ammonia solution as a pH modifier (in Example 4a) or triethanolamine and ethylenediamine (in Example 4b) to provide a composition comprising a pH-stabiliser and a dispersed polyurethane. Other suitable pH modifiers include 2-amino-2-methyl-1-propanol, triethylamine, and N,N-diisopropylethylamine. The addition of silver nitrate to the composition results in the spontaneous reduction of Ag⁺ to Ag⁰ and the generation of AgNP-functionalised polyurethane polymers.

Example 5 describes a method of functionalising polyol blends for use in urethane resin systems. AgNP functionalised urethane was achieved by polyol reduction of Ag⁺ to Ag⁰. This was followed by addition of an isocyanate hardener to crosslink the resin system and form the polyurethane composite comprising AgNP-functionalised polyols.

Example 6 describes the use of The Japanese Industrial Standard Committee method, JIS Z 2801, to test the antibacterial activity of AgNP-functionalised waterborne polyurethane and the urethane composite comprising AgNP-functionalised polyols against S. aureus. Strong antibacterial activity was exhibited by the Ag functionalised urethane composite resin demonstrating its efficacy for use as an antibacterial coating in urethane systems.

### Method of Preparation of a Coated Substrate

The AgNP-functionalised polymer may be used in the preparation of a coating. It has been found that the AgNP-functionalised polymer herein described may be used in a coating composition in substantially the same way as the corresponding non-functionalised polymer. Accordingly, the AgNP-functionalised polymer may be applied to a substrate and allowed to set. The mode of setting will depend on the type of polymer, and may be via polymerisation of the polymer such as cross-linking, by the evaporation of a solvent in the composition to form a hard layer, by the cross-linking of a second cross-linkable polymer in the composition, or by another mechanism in which the composition hardens to form a coating.

The functionalised polymer may be combined with pigments, dyes and/or fillers to form a coating composition. However, as noted above, the polymer may be combined with pigments, dyes and/or fillers prior to functionalisation of the polymer with AgNPs. The functionalised polymer may further be combined with a second polymer. The second polymer may be a cross-linkable or curable polymer to improve setting of the composition to form a coating.

In an example, a composition comprising an AgNP-functionalised acrylic polymer or a AgNP-functionalised 1-component polyurethane is applied to a substrate and allowed to set to a solid coating, according to standard methodologies for non-functionalised components.

In an example, a 2-component polyurethane coating composition comprising an AgNP-functionalised polyol is combined with an isocyanate component, applied to a substrate, and allowed to set to a solid coating, according to standard methodologies for non-functionalised components.

Advantageously, the AgNP-functionalised polymer of the present invention may be applied by techniques that are standard in the application of domestic, commercial, and industrial coatings, and achieve antiviral activity. For example, the coating may be applied by spraying, brushing, rolling, pouring in place. The coatings may also be printed onto a surface.

Advantageously, no further treatment of the AgNP-functionalised polymer is required prior to applying the AgNP-functionalised polymer to a substrate. For example, no heat treatment or UV irradiation of the AgNP-functionalised polymer is required prior to application of the coating to a substrate to achieve antiviral activity of the coating.

### Antibacterial Properties

The AgNP-functionalised polymers described herein have been found to have substantial antibacterial activity. As shown in Examples 2 and 6, AgNP-functionalised waterborne polymers have antibacterial activity against S. aureus of greater than 99.9% compared to control.

### Antiviral Properties

Antibacterial activity of a composite is not predictive of antiviral activity. The strong antibacterial activity of AgNP-functionalised waterborne polyurethane polymers shown in Example 6 is therefore not indicative of these polymers having strong antiviral activity.

Surprisingly, substrates comprising the coatings herein described have been found to have substantial antiviral activity.

Advantageously, no heat treatment or UV irradiation of the applied coating is required to achieve antiviral activity of the coating.

Advantageously, advanced application techniques such as vapour deposition, or application under an inert atmosphere, are not required to achieve antiviral activity of the coating.

It cannot be presumed that antiviral activity observed against one type of virus will translate into broad-spectrum antiviral activity across several virus classes, or antiviral activity against a different class of virus. Indeed, the variability in the observed antiviral activity of the coatings described in the Examples herein shows that the mere presence of AgNPs, or a particular concentration of AgNPs, is not sufficient to lead to a conclusion that a coating comprising AgNPs will have significant antiviral activity.

Antiviral activity of the coatings was demonstrated for Feline Calicivirus (FCV), Human Coronavirus (HC) and Influenza A Virus (H1N1). H1N1 is an enveloped Class V virus according to the Baltimore Virus Classification system, and its genetic information is antisense single-stranded RNA.¹¹ HC and FCV are both Class IV viruses according to the Baltimore Virus Classification system, meaning they have sense single-stranded RNA genomes. H1N1 and HC are enveloped while FCV is not.^{12 13} FCV and human norovirus are highly comparable in terms of size and structure, and for this reason FCV is often used as a human norovirus surrogate.

Example 7 demonstrates the antiviral activity of substrates coated with compositions comprising AgNP-functionalised acrylic polymers, AgNP-functionalised polyurethane polymers, and 2-part polyurethane polymers comprising AgNP-functionalised polyols. Analysis of antiviral properties of the coated substrates showed substantial variability in antiviral efficacy depending on the category of virus and the type of polymer. The inventors believe that the assessment of antiviral activity of the coatings against FCV, HC and H1N1 described herein allows a reasonable scientific prediction that the coatings described herein exhibit antiviral activity across enveloped and non-enveloped viruses. Antiviral activity was demonstrated by coatings comprising functionalised polyol, polyurethane and acrylic polymers. Superior, broad spectrum antiviral activity was surprisingly demonstrated by AgNP-functionalised waterborne polyurethane dispersions.

Substrates coated with the waterborne AgNP-functionalised acrylate (NeoCryl™ XK-98) described in Example 1 showed antiviral activity against all viral types. The coating comprising 0.25 wt. % Ag⁰ demonstrated a reduction of 99.95%, 75.45% and 22.38% in viral titer against FCV, HC and H1N1, respectively.

Substrates coated with the waterborne AgNP-functionalised styrene-acrylate (Carboset™) described in Example 3 showed antiviral activity against all viral types. The coating demonstrated a reduction of 99.994%, 98.14% and 75.45% in viral titer against FCV, HC and H1N1, respectively.

Substrates coated with the 1-component AgNP-functionalised polyurethane described in Example 4a showed exceptional antiviral activity against all viral types. The coating demonstrated a reduction of 94.38%, 99.86% and 98.64% in viral titer against FCV, HC and H1N1, respectively.

Substrates coated with the 2-component polyurethane comprising functionalised polyol described in Example 5 showed antiviral activity against all viral types. The coating demonstrated a reduction of 43.77, 33.93 and 22.38% in viral titer against FCV, HC and H1N1, respectively. The coating also demonstrated a reduction in S. aureus of 99.98%.

Antiviral activity against FCV of greater than 94% (1.25 Log 10) reduction was observed for coatings comprising functionalised 1-component polyurethanes, acrylic polymers and styrene-acrylic polymers. Lower, yet still meaningful, antiviral activity was observed against Feline calicivirus for the 2-component polyurethane comprising AgNP-functionalised polyol, with a viral reduction of about 44% (0.25 Log 10).

Antiviral activity against HC of between 56.4% and 99.9% was observed for coatings comprising AgNP-functionalised polyurethanes, acrylic polymers and styrene-acrylates. Lower, yet still meaningful, antiviral activity was observed against Human Coronavirus for the 2-component polyurethane coating composition comprising AgNP-functionalised polyol.

Surprisingly, the most effective tested coating against FCV was the 0.5% functionalised waterborne styrene-acrylate, with a viral reduction of 99.994% (4.25 Log 10). This coating also provided viral reductions against HC of 1.73 Log 10 and against H1N1 of 0.61 Log 10.

Surprisingly, the broadest spectrum antiviral activity was observed for 0.5 wt. % functionalised 1-component polyurethane. For FCV, HC and H1N1, viral reduction of greater than 94.4% was observed.

Evidence of antibiotic activity of a coating is not sufficient to lead to a conclusion that the coating will have an effective level of antiviral activity. Analysis of antibiotic activity of acrylic and polyurethane coatings described in Examples 2 and 6 shows a uniformly strong reduction of bacteria count. However, the antiviral activity of the coatings demonstrated in Example 7 confirms that strong antibacterial activity is not necessarily indicative of strong antiviral activity. For instance, the Examples show uniformly strong antibacterial activity of the coatings of the present invention across bacterial genera whereas Example 7 shows coatings varied in their antiviral activity depending on the polymer type and the virus type.

### EXAMPLES

### Example 1—Preparation of Functionalised Acrylic Emulsion

A self-crosslinking acrylic emulsion, Neocryl™ XK-98 (DSM Coating Resins, LLC) was functionalised at room temperature using the following general synthesis method.

Aqueous AgNO₃ (0.25 mL) was added to 5 g of Neocryl™ XK-98 at various concentrations to give a final Ag concentration in the Neocryl™ XK-98 of between 0.01% and 1%. The AgNO₃ was added slowly to the Neocryl™ XK-98 while under high shear overhead mixing to disperse the AgNO₃. The samples were then left to agitate on a shaking table overnight, during which time the samples containing Ag produced a colour change from clear to yellow/orange, and then to orange/brown. This is due to the phenomenon of localised surface plasmon resonance, indicating the reduction of Ag⁺ to Ag⁰ was completed during the synthesis.

UV-Visible spectroscopy of the liquid AgNP-functionalised composition showed a peak at 430 nm, which is indicative of localised surface plasmon resonance and thus indicative of silver nanoparticles.

The AgNP functionalised sample was applied to a substrate and allowed to set.

The silver leach rate of the set sample was assessed by submersion of the sample in water for 24 hours. The leachate was measured for the presence of Ag via atomic absorption spectroscopy. The silver leach rate was found to be 4.0 (±0.9) ppb per gram of set sample.

Scanning electron microscopy of the set sample showed an average AgNP particle size of 13 nm (±7 nm), and an AgNP particle size distribution of between 4 and 30 nm.

### Example 2—Antibacterial Activity of Functionalised Acrylic Coating

Quantitative antibacterial testing of AgNP-functionalised Neocryl™ XK-98 prepared according to Example 1 was performed against E. coli, S. aureus and L. monocytogenes using the standard method The Japanese Industrial Standard Committee method JIS Z 2801. The general method for JIS Z 2801 antibacterial analysis is as follows. The test microorganism is prepared, usually by growth in a liquid culture medium. The suspension of test microorganism is standardised by dilution in a nutritive broth. Control and test surfaces are inoculated with microorganisms, and then the microbial inoculum is covered with a thin, sterile film. Covering the inoculum spreads it, prevents it from evaporating, and ensures close contact with the antibacterial surface. Microbial concentrations are determined at “time zero” by elution followed by dilution and plating to agar. A control is run to verify that the neutralisation/elution method effectively neutralises the antibacterial agent in the antibacterial surface being tested, and to confirm that the elution method is washing the microorganism off the surface. Inoculated, covered control and antibacterial test surfaces are allowed to incubate undisturbed in a humid environment for 24 hours, usually at body temperature. After incubation, microbial concentrations are determined. Reduction of microorganisms relative to the control surface is calculated. The results are shown in Table 1.

TABLE 1
Antibacterial activity of AgNP-functionalised Neocryl ™ XK-98

| | AgNP | E. coli | S. aureus | L. monocytogenes |
|---|---|---|---|---|
| | wt. % | Reduction | reduction | reduction |
| Acrylic | 0.1 | >99.998% | >99.997% | >99.99994% |
| (Neocryl ™ | 0.25 | >99.998% | >99.997% | >99.99994% |
| XK-98) | 0.5 | >99.998% | >99.998% | >99.99994% |

### Example 3—Preparation of Functionalised Styrene-Acrylic Emulsion

A self-crosslinking water-borne styrene-acrylic copolymer emulsion, Carboset™ 3090 (Lubrizol Advanced Materials, Inc.), was functionalised using the following general synthesis method.

Aqueous AgNO₃ (2.5 mL) was added to 10 g of Carboset™ 3090 dropwise under mixing at room temperature to give a final concentration of between 0.25-0.5% w/w Ag⁺in solution. The solution was stirred for a further 5 minutes before being transferred to a shaking water bath at 80° C. for 24 hours. Over this time the samples underwent a colour change from white to yellow/orange then to brown. This is due to the phenomenon of localised surface plasmon resonance, indicating the reduction of Ag⁺ to Ag⁰ was completed during the synthesis.

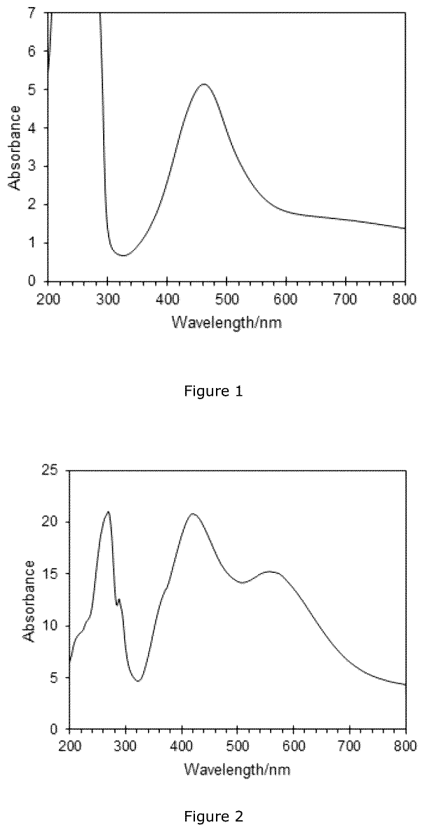

UV-Visible spectroscopy of the liquid AgNP-functionalised composition showed a peak at 462 nm, which is indicative of localised surface plasmon resonance and thus indicative of silver nanoparticles. See FIG. 1. XRD confirmed the presence of silver.

AgNP functionalised styrene-acrylic emulsion was applied to a substrate and allowed to set.

The silver leach rate of the set sample was assessed by submersion of the sample in water for 24 hours. The leachate was measured for the presence of Ag via atomic absorption spectroscopy. The silver leach rate was found to be 4.4 (±1.2) ppm per gram of set sample.

### Example 4a—Preparation of Functionalised One-Component Polyurethane Coating

A waterborne, self-crosslinking polyurethane dispersion, Aptalon™ W8060 (Lubrizol Advanced Materials, Inc.), was functionalised with silver nanoparticles using the following general synthesis method. Aqueous ammonia solution (28%) was added to 10 g of Aptalon™ W8060 resin under stirring to give a final NH₃ concentration in solution of between 0.2 and 2.6% w/v. The samples were mixed for a further five minutes before addition of aqueous AgNO₃ (2.5 mL) was added dropwise under mixing at room temperature to give a final concentration of Ag⁺ in the solution of between 0.1-0.75% w/w. The samples were then left to agitate on a shaking table for 24 hours at room temperature, during which time the samples containing Ag produced a colour change from clear to yellow/orange, and then to dark brown.

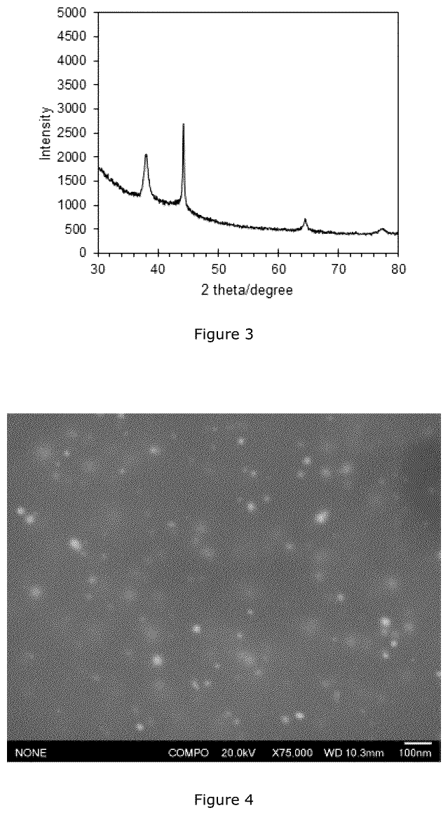

UV-Visible spectroscopy of the liquid AgNP-functionalised composition showed a peak at 419 nm, which is indicative of localised surface plasmon resonance and thus indicative of silver nanoparticles. A peak at 557 nm is indicative of a second LSPR peak, suggesting a bimodal size distribution or anisotropy. See FIG. 2. XRD confirmed the presence of silver. See FIG. 3.

The AgNP-functionalised polyurethane dispersion was applied to a substrate and allowed to set.

The silver leach rate of the set sample was assessed by submersion of the sample in water for 24 hours. The leachate was measured for the presence of Ag via atomic absorption spectroscopy. The silver leach rate was found to be 17.75 ppb per gram of set sample.

Scanning electron microscopy of the set sample showed an average AgNP particle size of 27 nm, minimum particle size of 15 nm and maximum particle size of 43 nm. See FIG. 4.

### Example 4b—Alternative pH Modifiers

The synthesis method of Example 4a was performed in which the ammonia was substituted with triethanolamine and ethylenediamine.

UV-Visible spectroscopy of the liquid AgNP-functionalised composition showed a peak at 420 nm, which is indicative of localised surface plasmon resonance and thus indicative of silver nanoparticles. XRD confirmed the presence of silver.

The AgNP functionalised polyurethane dispersion was applied to a substrate and allowed to set.

The silver leach rate of the set sample was assessed by submersion of the sample in water for 24 hours. The leachate was measured for the presence of Ag via atomic absorption spectroscopy. The silver leach rate was found to be 82.91 ppb per gram of resin. Repetition of the test gave a result of 11.8 (±8.0) ppb silver per gram of set sample.

Transmission electron microscopy of the set sample showed an average AgNP particle size of 5.2 nm (±2.2 nm), with a particle size distribution of between 2 nm and 15 nm.

### Example 5—Preparation of Functionalised Polyol for a 2-Part Polyurethane Coating

A 100% solids 2-part urethane coating (Alberdingk Boley, Inc.) was functionalised with AgNPs by functionalising the branched, castor oil-based polyol resin component with AgNPs before addition of the polyisocyanate blend hardener. The polyol resin was functionalised by following the following method. AgNO₃ (0.32 g) was added to 99.8 g of resin under high shear mixing to give a final concentration of about 0.2 wt % Ag⁺. The mixture was transferred to a shaking water bath at 60° C. for 4 hours. During this time the resin underwent a colour change to a yellow/brown indicating the formation of AgNPs.

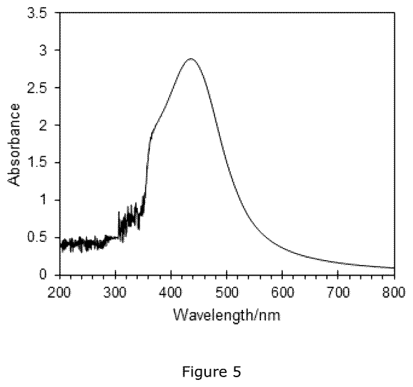

UV-Visible spectroscopy of the liquid AgNP-functionalised composition showed a peak at 435 nm, which is indicative of localised surface plasmon resonance and thus indicative of silver nanoparticles. See FIG. 5.

The AgNP functionalised polyol was mixed with the polyisocyanate blend hardener in a ratio of 1:0.39 by mass and allowed to set. The set sample comprised 0.14 wt. % Ag.

The silver leach rate of the set sample was assessed by submersion of the sample in water for 24 hours. The leachate was measured for the presence of Ag via atomic absorption spectroscopy. The silver leach rate was found to be about 6.6 (±1.3) ppb Ag per gram of set sample.

Transmission electron microscopy of the set sample showed an average AgNP particle size of 8.5 nm (±2.8 nm), and an AgNP particle size distribution of between 5 and 19 nm.

### Example 6—Antibacterial Analysis

Quantitative antibacterial testing of an AgNP-functionalised waterborne polyurethane polymer, prepared according to the methodology of Example 4a, was performed using the standard method The Japanese Industrial Standard Committee method JIS Z 2801. The general method for JIS Z 2801 is as follows. The test microorganism is prepared, usually by growth in a liquid culture medium. The suspension of test microorganism is standardised by dilution in a nutritive broth (this affords microorganisms the opportunity to proliferate during the test). Control and test surfaces are inoculated with microorganisms, and then the microbial inoculum is covered with a thin, sterile film. Covering the inoculum spreads it, prevents it from evaporating, and ensures close contact with the antimicrobial surface. Microbial concentrations are determined at “time zero” by elution followed by dilution and plating to agar. A control is run to verify that the neutralisation/elution method effectively neutralises the antimicrobial agent in the antimicrobial surface being tested. Inoculated, covered control and antimicrobial test surfaces are allowed to incubate undisturbed in a humid environment for 24 hours, usually at body temperature. After incubation, microbial concentrations are determined. Reduction of microorganisms relative to the control surface is calculated. The results are shown in Table 2.

TABLE 2
Antibacterial test results against S. aureus using JIS-Z-2801
standard for a 2 hour contact time.

| | | | Percent | Log10 |
|---|---|---|---|---|
| | | | Reduction | Reduction |
| | | | Relative To | Relative |
| | | Average | The Two- | To The |
| Contact | Surface | CFU/mL | Hour | Two-Hour |
| Time | Specimen | Recovered | Control | Control |
| Time | 0-Hour Acrylic | 5.433 × 10⁵ ± | N/A | N/A |
| Zero | Control | 3.071 × 10⁴ | | |
| Two | 2-Hour Acrylic | 5.150 × 10⁵ ± | N/A | N/A |
| Hours | Control | 9.009 × 10⁴ | | |
| | 2-Hour AgNP | <1.000 × 10² ± 0 | 99.9806% | 3.712 |
| | functionalised | | | |
| | polyurethane | | | |
| | (Aptalon) | | | |

Quantitative antibacterial testing of a set sample of AgNP-functionalised urethane (comprising Ag functionalised polyol) from Example 5 was performed against S. aureus using The Japanese Industrial Standard Committee method JIS Z 2801 as described above. The results are shown in Table 3.

TABLE 3
Antibacterial activity of 2-component polyurethane
comprising AgNP-functionalised polyol

| | Ag NP wt. | S. aureus |
|---|---|---|
| | % | reduction |
| Unfunctionalised | 0 | 6.07% |
| urethane | | |
| 2-component polyol | 0.14 | 99.98% |
| polyurethane | | |

### Example 7—Antiviral Analysis

Quantitative antiviral testing of AgNP-functionalised coatings Neocryl™ XK-98, polyurethane comprising AgNP-functionalised polyol, AgNP-functionalised Carboset™ CR-3090, and AgNP-functionalised Aptalon™ W3090 coatings was performed using the standard method The Japanese Industrial Standard Committee method JIS Z 2801, adapted for determining antiviral activity. The methodology is as follows:

### Test Parameters

Samples were UV sterilized on each side for 15

| Test Substance Preparation | Samples were UV sterilized on each side for 15 | |
|---|---|---|
| | minutes before testing. | |
| Total Organic Soil Load | 5% fetal bovine serum (FBS) | |
| Number of Replicates Per Lot | Double | |
| Contact Time | 120 | minutes |
| Inoculum Volume per Carrier | 0.200 | ml |

| | |
|---|---|
| Exposure Temperature | Room temperature (23.7-24.7° C.) and 39-42% |
| | Relative Humidity (RH) |
| Neutralization Method(s) | Dilution method using: 2% FBS EMEM and influenza |
| | infection media (0% FBS supplemented with Bovine |
| | Serum Albumin and TPCK Trypsin) |

### Test Procedure

Stock virus was thawed and was supplemented with an organic soil load. The samples were UV sterilized and placed into individual sterile plastic Petri dishes. A 0.200 ml inoculum of virus suspension was pipetted onto the surface of each of the test samples. The contact time began as soon as the inoculum came in contact with the surface. A plastic cover film was placed over the sample to evenly spread the inoculum over the surface, and the Petri dish was covered with the lid. The test carriers remained in a temperature and humidity stable environment for the duration of the contact time(s). At the completion of each contact time, the cover film was aseptically removed, and both the cover film and carrier were rinsed with an aliquot of test media. The surface of the carrier was scraped with a sterile cell scraper. The resultant volume was aseptically collected and diluted by serial 10-fold dilutions. The virus recovery control carrier was neutralized in the same manner as the test suspensions. Following neutralization, the viral suspensions were quantified to determine the levels of infectious virus using standard cell culture (e.g., TCID50) or plaque assay techniques. Assay trays/plates were incubated for the period most suitable for the virus-host cell system (e.g., 5-7 days). After the incubation period the assay was scored for the presence/absence of test virus and cytotoxic effects. The appropriate calculations were performed (e.g., Spearman-Karber) to determine viral titers and levels of test substance cytotoxicity, where applicable. Log 10 and percent reductions were computed for test suspensions relative to the control suspensions.

### Success Criteria

The following measures are met to ensure the acceptability of virucidal efficacy data:
The virus titer control demonstrates obvious and or typical cytopathic effects on the monolayers unless a detection method other than cytopathic effect is used.
Neutralization of the test substance with a low titer (e.g. 1000-5000 infective units) of the test virus is demonstrated.
Quantification of the test and control parameters is conducted at a minimum of four determinations per dilution.

The product performance criteria follow:
The log and percent reduction of the test virus following exposure to the test substance are calculated however, there is no minimum reduction level to qualify as “passing” or an “efficacious” product

### Calculations and Statistical Analysis

The TCID50 (Tissue Culture Infectivity Dose) represents the endpoint dilution where 50% of the cell cultures exhibit cytopathic effects due to infection by the test virus. The endpoint dilution at which 50% of the host cell monolayers exhibit cytotoxicity is termed the Tissue Culture Dose (TCD50). The TCID50, and TCD50 was determined using the Spearman-Kärber method and calculated as follows:

$$\\ Negative logarithm of endpoint titer = [ - Log of first dilution inoculated ] - [ \begin{matrix}( ( sum of \% mortality at each dilution / 100 ) - 0.5 ) \times \\ Logarithm of dilution\end{matrix} ]$$

The result of this calculation is expressed as TCID50/0.1 ml (or volume of dilution inoculated) for the test, virus control, and neutralization control and TCD50/0.1 ml (or volume of dilution inoculated) for the cytotoxicity control.

The log reduction in viral titer was calculated as follows:

Plate Recovery Control Log 10 TCID50−Virus-Test Substance Log 10 TCID50

The percent reduction in viral titer was calculated as follows:

$$\\ Percent Reduction = 1 - ( C / B ) \times 100 , where$$

$$\\ B = Average TCID 50 of virus in control suspensions , and$$

$$\\ C = Average TCID 50 of virus in virus ‐ test suspensions .$$

The presence of any test substance cytotoxicity were taken into account when calculating the log and percent reductions in viral titer.

If multiple virus control and test replicates were performed, the average TCID50 of each parameter was calculated and the average result used to calculate the log reductions in viral titer.

### Study Conclusion

The purpose of the study was to determine the virucidal efficacy of coatings of the present invention. To demonstrate antiviral activity against a range of virus types, the coatings were tested against Feline calicivirus Strain F-9, Human coronavirus Strain 229E, and Influenza A virus (H1N1) Strain A/PR/8/34, each supplemented with a 5% fetal bovine serum (FBS) organic soil load, at a contact time of 120 minutes, at room temperature (23.7-24.7° C. and 39-42% RH).

Feline calicivirus, Strain F-9, ATCC VR-782: The Virus Control demonstrated an average viral titer of 7.89 Log 10 TCID50 per 0.100 ml.

Human coronavirus, Stain 229E, ATCC VR-740: The Virus Control demonstrated an average viral titer of 6.00 Log 10 TCID50 per 0.100 ml.

Influenza A virus (H1N1), Strain A/PR/8/34, ATCC VR-1469: The Virus Control demonstrated an average viral titer of 6.00 Log 10 TCID50 per 0.100 ml.

The evaluated test substances demonstrated average log/percent reductions in viral titer as shown in Tables 4 to 6, below:

TABLE 4
Antiviral activity of AgNP-functionalised polymer coatings against FCV

| | [AgNP], | Feline Calicivirus | % |
|---|---|---|---|
| Polymer type | wt. % | (log 10) | reduction |
| Waterborne 1 component | 0.5 | 1.25 | 94.38 |
| polyurethane (Aptalon W8060) | | | |
| | 0.1 | 2.82 | 99.85 |
| Waterborne acrylic polymer | 0.25 | 3.3 | 99.95 |
| (Neocryl XK-98) | | | |
| Waterborne styrene-acrylate | 0.5 | 4.25 | 99.994 |
| copolymer (Carboset 3090) | | | |
| 2-component polyol polyurethane | 0.14 | 0.25 | 43.77 |

TABLE 5
Antiviral activity of AgNP-functionalised polymer coatings against HC

| | [AgNP], | Human Coronavirus | % |
|---|---|---|---|
| Polymer type | wt. % | (log 10) | reduction |
| Waterborne 1 component | 0.5 | 2.86 | 99.86 |
| polyurethane (Aptalon W8060) | | | |
| Waterborne acrylic polymer | 0.1 | 0.36 | 56.35 |
| (Neocryl XK-98) | 0.25 | 0.61 | 75.45 |
| Waterborne styrene-acrylate | 0.5 | 1.73 | 98.14 |
| copolymer (Carboset 3090) | | | |
| 2-component polyol polyurethane | 0.14 | 0.18 | 33.93 |

TABLE 6
Antiviral activity of AgNP-functionalised polymer coatings against H1N1

| | [AgNP], | Influenza A virus | % |
|---|---|---|---|
| Polymer type | wt. % | H1N1 (log 10) | reduction |
| Waterborne 1 component | 0.5 | 1.86 | 98.64 |
| polyurethane (Aptalon W8060) | | | |
| Waterborne acrylic polymer | 0.1 | 0.25 | 41.12 |
| (Neocryl XK-98) | 0.25 | 0.11 | 22.38 |
| Waterborne styrene-acrylate | 0.5 | 0.61 | 75.45 |
| copolymer (Carboset 3090) | | | |
| 2-component polyol | 0.14 | 0.11 | 22.38 |
| polyurethane | | | |

### REFERENCES

¹ Rakowska, Communications Materials, (2021) 2:53
² S.-D. Walji and M. G. Aucoin, “A critical evaluation of current protocols for selfsterilizing surfaces designed to reduce viral nosocomial infections,” Am. J. Infect. Control 48, P1255 (2020)
³ A. Kumar et al., “Silver-nanoparticle-embedded antimicrobial paints based on vegetable oil,” Nat. Mater. 7(3), 236-241 (2008)
⁴ A. M. Fayaz et al. “Inactivation of microbial infectioiusness by silver nanoparticles-coated condom: A new approach to inhibit HIV- and HSV-transmitted infection” Int. J. Nanomed. 7, 5007 (2012).
⁵ Jeremiah, S. S.; Miyakawa, K.; Morita, T.; Yamaoka, Y.; Ryo, A. Potent Antiviral Effect of Silver Nanoparticles on SARS-CoV-2. Biochem Biophys Res Commun 2020, 533 (1), 195-200.
⁶ Elechiguerra, J. L.; Burt, J. L.; Morones, J. R.; Camacho-Bragado, A.; Gao, X.; Lara, H. H.; Yacaman, M. J. Interaction of Silver Nanoparticles with HIV-1. Journal of Nanobiotechnology 2005, 3 (1), 6.
⁷ Jeremiah, S. S.; Miyakawa, K.; Morita, T.; Yamaoka, Y.; Ryo, A. Potent Antiviral Effect of Silver Nanoparticles on SARS-CoV-2. Biochem Biophys Res Commun 2020, 533 (1), 195-200.
⁸ Sinclair, T. R.; Hengel, S. van den; Raza, B.; Rutjes, S.; Husman, A. M. de R.; Peijnenburg, W.; Roesink, H. D. W.; Vos, W. M. de. Surface Chemistry-Dependent Antiviral Activity of Silver Nanoparticles. Nanotechnology 2021.
⁹ G. Reina et al., “Hard nanomaterials in time of viral pandemics,” ACS Nano 14, 9364 (2020).
¹⁰ J. Zhou et al., “Progress and perspective of antiviral protective material,” Adv. Fiber Mater. 2, 123-139 (2020).
¹¹ Bruslind, L. The Viruses. In General Microbiology; Oregon State University
¹² Liu, D. X.; Liang, J. Q.; Fung, T. S. Human Coronavirus-229E, -OC43, -NL63, and -HKU1 (Coronaviridae). Encyclopedia of Virology 2021, 428-440.
¹³ He, P.; Zhou, H.; Zhao, W.; He, J.; Li, R.; Ding, Y.; Chen, Q.; Liu, L.; Wei, Z.; Huang, W.; Chen, Y. Complete Genome Sequence of Feline Calicivirus Strain GX01-2013 Isolated from Household Cats in Guangxi, Southern China. Genome Announc 2016, 4 (5)

1. A method of inactivating a virus on a substrate, comprising the steps of:
(a) applying a liquid composition to the substrate in an amount sufficient to inactivate the virus, the liquid composition comprising a polymer bonded to silver nanoparticles; and
(b) curing or cross-linking the polymer to form a coating on the surface of the substrate;
wherein the polymer is selected from a polyurethane polymer, an acrylic polymer, and a polyol.

2. The method as claimed in claim 1, wherein the virus is selected from calicivirus, human norovirus, human coronavirus, and influenza A H1N1 virus.

3. The method as claimed in claim 1, wherein the polymer is bonded to silver nanoparticles by functional groups of the polymer.

4. The method as claimed in claim 3, wherein the functional groups are selected from carboxyl, sulfonate, ammonium, ester, ether, amine, imine, nitrile, epoxide, hydroxyl, carbamate, and carbonyl groups.

5. The method as claimed in claim 1, wherein the polymer is a polyurethane polymer dispersed in water.

6. The method as claimed in claim 1, wherein the acrylic polymer is selected from methyl acrylate, ethyl acrylate, butyl acrylate, methyl methacrylate, butyl methacrylate, and styrene-acrylic polymer.

7. The method as claimed in claim 1, wherein the polyol is selected from polyether polyol, polyester polyol, polycarbonate polyol, polyacrylate polyol, and poly(meth)acrylate polyol.

8. The method as claimed in claim 1, wherein the coating comprises at least 0.05 wt. % Ag⁰.

9. (canceled)

10. The method as claimed in claim 1, wherein the coating has a leach rate of Ag of less than 100 parts per billion per gram of set composite per day (ppb/g/day).

11. The method as claimed in claim 1, wherein the coating achieves an average percent reduction in viral titer by at least 20%, according to the JIS Z 2801 test protocol.

12. The method as claimed in claim 1, wherein the coating achieves an average percent reduction in H1N1 viral titre of at least 20%, according to the JIS Z 2801 test protocol.

13. The method as claimed in claim 1, wherein the coating achieves an average percent reduction in human coronavirus viral titre of at least 50%, according to the JIS Z 2801 test protocol.

14. The method as claimed in claim 1, wherein the coating achieves an average percent reduction in feline calicivirus viral titre of at least 40%, according to the JIS Z 2801 test protocol.

15. The method as claimed in claim 1, wherein the polymer comprises a polyurethane polymer dispersed in water and the coating achieves an average percent reduction in viral titre of at least 90%, according to the JIS Z 2801 test protocol.

16. The method as claimed in claim 1, wherein the polymer comprises a styrene acrylic copolymer and the coating achieves an average percent reduction in viral titre of at least 75%, according to the JIS Z 2801 test protocol.

17.-18. (canceled)
